(19) United States
(12) Patent Application Publication
(10) Pub. No.: US 2011/0119181 A1
(43) Pub. Date: May 19, 2011

(54) Secure limit card

(76) Inventors: Barry D. Puleo, Kenbridge, VA (US); James B. Daniel, II, Kenbridge, VA (US)

(21) Appl. No.: 09/945,920

(22) Filed: Sep. 4, 2001

(51) Int. Cl. G06Q 40/00; G06Q 30/00

(52) U.S. Cl. 705/41

(57) ABSTRACT

A method and system for issuing a limit card to a card requestor for a self imposed cash amount to make a product or service purchase with the transaction being conducted solely the vendor and the financial card sponsor. The method includes a financial card sponsor or authorized dealer issuing a card to a card requestor who immediately or subsequently activates the card by depositing funds to the card at a card activating entity. The cardholder gives a monetary amount to a clerk or cash accepting device at any participating entity which then credits the card with the monetary amount less any service charge. The activating entity gives the cardholder a receipt bearing the date and amount when the card is purchase. The remainder of the deposit is electronically forwarded to the sponsor who deducts the commission and activates the cardholder's account. The cardholder submits the card to a vendor to purchase a product or service, and the vendor accesses the account and carries out the transaction solely with the sponsor. The sponsor transfers to the vendor to close the transaction, and the vendor delivers the product or service to the cardholder.

### BACKGROUND OF THE INVENTION

1. Field of the Invention

The present invention relates to secured and limit cards and more particularly to a limit card activated with a specific cash amount which is convenient for use at any credit card servicing account and usable for general and Internet shopping and to eliminate security problems associated with traditional credit cards which can be accessed by unlawful or unauthorized activity.

2. Description of the Prior Art

Generally financial institutions provide secured and unsecured credit cards with unsecured credit cards issued to individuals having a good credit rating and secured credit cards issued to individuals who can produce a security interest in an asset, usually a savings account, to cover all or part of the debt. More critically monitored secured credit cards are issued to individuals having fair or poor credit rating or no credit rating at all.

Shopping for goods and services is rapidly changing with the technological advances in communication and e-commerce via the Internet, and these advances and changes are expected to result in exponential growth of the world economy. This new inner-connectivity between people and businesses, involving computers, databases, personal information and financial transactions create new security and privacy concerns for consumers. Conventional payment transactions by a traditional credit card are no longer safe, and many consumers are very apprehensive about submitting a credit card number on line when purchasing an item regardless of the security claims made by Internet business operations. The traditional Internet credit practice may leave a person's credit line and personal information unprotected from computer hackers and thieves.

There are numerous issued patents covering methods and systems for issuing a secured credit card. See for example U.S. Pat. No. 5,950,179. While secured credit cards provide a limited form of credit card use by a card holder, its ownership and use still require some assets to cover the indebtedness incurred. Moreover, the conventional credit card does not provide the privacy currently desired by today's consumers to prevent invasion of credit lines, personal information and other assets.

Thus there is a need for a secure limit card for those with or without assets upon which to support a conventional credit card and who have the greatest desire for privacy and security which can be used to purchase goods or services at any authorized credit card entity on the Internet which until now has only been possible by the use of conventional credit cards. It is to these purposes that the present invention is directed with the intent that the card resulting from this effort be a model for all future financial transactions.

### SUMMARY OF THE INVENTION

An objective of the secured limit card is to provide the consumer utilizing such a card with a prepaid account that is recognized and accepted by all retail businesses accepting any traditional credit card but ensures maximum security and privacy of the consumer's account and personal information involved with the financial transaction.

Another objective of the present invention is to provide a secured limit card which can be used to purchase goods and services over the Internet.

Yet another objective of the present invention is to provide a card of the type described which has a self imposed limit account based on the amount of money deposited by the consumer onto the card after the card is acquired and activated and prior to making a purchase.

Yet still another further objective of the present invention is to provide a card of the type described which will limit the risk of loss to the cardholder to the amount the cardholder purchased and deposited on the card should the card or card number be stolen and used wrongfully by another.

A further objective of the present invention is to provide a card of the type described which, to secure privacy of purchase information, would be in an anonymous account known only to the financial card sponsor having a numerical account number assigned solely by that entity.

Yet still another further objective of the present invention is to provide a card of the type described which will limit the transaction associated with the purchase by a consumer utilizing the card, to a transaction solely between the financial card sponsor and the vendor.

A further objective of the present invention is to provide a card of the type described that can be purchased and activated at an automated facility designed to receive cash in various amounts and dispense limit cards with accounts substantially equal to the money deposited.

From the objectives set forth above it can be seen that the present invention resides in a method and system for issuing a limit card to a card requestor for a self imposed cash amount to make a product or service purchase with the transaction being conducted solely between the vendor and the financial card sponsor. The method includes a financial card sponsor or authorized dealer issuing a card to a card requestor (“cardholder”) who immediately or subsequently activates the card by depositing funds onto the card at a card activating source or entity. The cardholder gives a monetary amount to a clerk or cash accepting device at any such participating entity (retailer, bank, terminal, etc.) which then credits the card with the monetary amount less any service charges. The service charge to the card activating entity is for the service of crediting the money onto the card. The issuing or activating entity gives the cardholder a receipt bearing the date and amount of deposit when the card is purchased.

The remainder of the deposit is forwarded electronically to the financial card sponsor who immediately deducts a commission and electronically activates a balance on the cardholder's account. The sponsor may alternatively issue a pin number or other security insuring means to the cardholder at the time of or just before activation which must be used each time by the cardholder to access the account. The use of such security insuring means may or may not be in the discretion of the cardholder.

The cardholder submits his or her card account number to a vendor for the purchase of a product or service, and the vendor accesses the account, acknowledges the account balance to be sufficient to make the desired purchase and proceeds to carry out the transaction solely with the financial card sponsor. The card sponsor immediately transfers the funds to the vendor to close the transaction, and the vendor ships or authorizes shipment of the product or service from the vendor or its representative or agent to the cardholder.

Participating card activation entities (those designated by the card sponsor) receive a service charge deemed reasonable through agreement with the financial card sponsor. All commissions are received up front before the card balance is activated. The limit card has no monetary value until the cardholder deposits money onto the card at a card activation site which eliminates any risk of the card being used fraudulently if lost or stolen before requesting his or her card.

The card account information is accessible only by the financial card sponsor, and no account statement is created for the cardholder unless the cardholder requests it. Thus a self imposed purchase limit is created by the requestor when the purchase is planned, and the card is obtained from a convenient and designated card supplier or activator.

The card, after activation and funding, can also be used by the cardholder to withdraw cash from the account (up to the cash balance of the account) from an appropriate servicing entity.

Thus there has been outlined the more important features of the invention in order that the detailed description that follows may be better understood and in order that the present contribution to the art may be better appreciated. There are, of course, additional features of the invention that will be described hereinafter and which will form the subject matter of the claims appended hereto. In that respect, before explaining at least one embodiment of the invention in detail, it is to be understood that the invention is not limited in its application to the arrangement of the components set forth in the following description or illustrated in the drawings. The invention is capable of other embodiments and of being practiced and carried out in various ways.

It is also to be understood that the phraseology and terminology employed herein are for the purpose of description and should not be regarded as limiting in any respect. Those skilled in the art will appreciate that the concept upon which this disclosure is based may readily be utilized as a basis for designing other structures, methods and systems for carrying out the several purposes of this development. It is important that the claims be regarded as including such equivalent methods and products resulting therefrom that do not depart from the spirit and scope of the present invention. The application is neither intended to define the invention, which is measured by its claims, nor to limit its scope in any way. The fees and service charges referred to above are merely a suggested means to obtain profits, and the card sponsor may choose other means to obtain profitability.

For a better understanding of the invention, its operating advantages and the specific results obtained by its use, reference should be made to the following detailed description taken in conjunction with the accompanying drawings wherein like characters of reference designate like parts throughout the several views.

### DESCRIPTION OF THE DRAWINGS

FIG. 1 shows a block diagram of the method of the present invention.

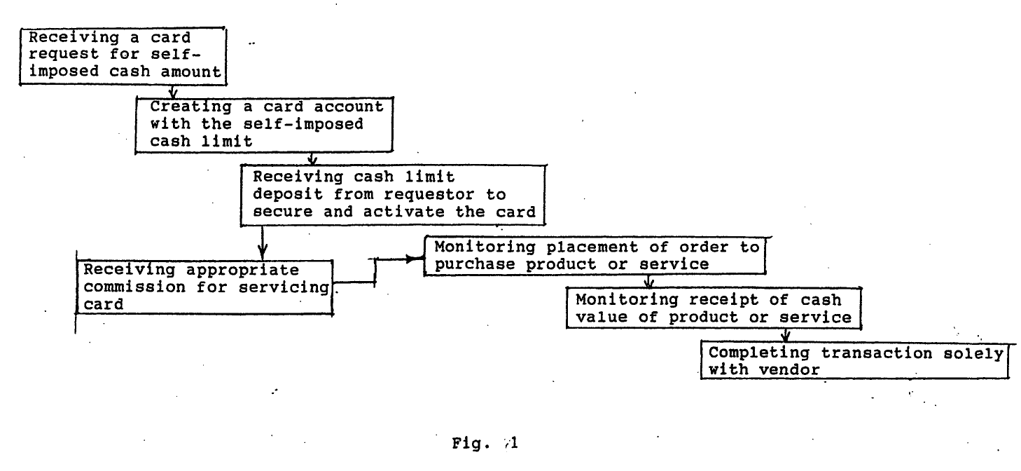

### DETAILED DESCRIPTION OF PREFERRED EMBODIMENT

The limit card of the present invention may be issued from a participating financial institution, retail business or automated dispenser. The card has the traditional 16 digit account number and is recognized as a credit card linked to the sponsoring institution. The card itself has the same dimensions and material composition of a traditional credit card and is thus readily recognized as such by all entities trading with or accepting credit cards. It is of no value until activated by the cardholder at a participating card activating entity and may be issued as a long term card requiring only a minimum balance to remain active or as a disposable prepaid line of credit.

When the cardholder plans to make a purchase, he or she pays a sufficient amount of money for the card purchase. At the cardholder's discretion, he or she may reuse the card as often as he or she feels secure so long as a minimum balance is maintained or may dispose of the card after one purchase (disposing of all funds in the account) and obtain a new card for additional purchases. The cardholder deposits money onto the limit card at any business that accepts credit cards, and the account is automatically credited for the amount of the deposit less any service charges. During the process of ordering merchandise, the business transaction takes place in the same manner as with a traditional credit card. However the security and privacy of the limit card keeps the cardholder unidentified, with the account information and paperwork conducted completely between the financial institution and the retail business unless the cardholder requests otherwise.

The process involved in the use of the card provides the holder of an issued and activated card with sufficient funds in the card account the same as or greater than the amount of cash needed to make the purchase. The card is activated by the financial card sponsor of the program with any entity associated with the program.

The cardholder places an order for products or services from a vendor, perhaps on the Internet, which is priced less than or equal to the card purchasing value. The transaction is closed by the cardholder using the cash value of the card to make the purchase and thereafter receiving the product or service in the usual manner.

When the requestor has a funded card in his possession and before he or she has entered into a purchase transaction, the card has some vulnerability since the entity placing the funds on the card has the card number and can access the funds if it chooses. This risk is reduced if the cardholder is issued a pin number or other security insuring means which must be provided by the individual attempting to use the card before it can be used. The risk is also reduced by utilizing the recommended procedure of the requestor entering into the sales transaction as quickly as possible without releasing custody of the card and before anyone else would have time to remove funds from it. This risk is usually covered by legislation or the financial card sponsor in dealing with normal and conventional credit cards.

The final transaction in the process is solely between the financial card sponsor and the vendor. When the vendor is assured that the cardholder's account balance is enough to make the desired purchase, the financial card sponsor is notified and immediately transfers the funds to the vendor without furnishing personal or account information to close the transaction. The goods or services are then shipped or authorized to be shipped from the vendor or its agent to the cardholder at a location he or she provides.

The following illustrated and described flow chart showing the method of the present invention will summarize the detailed description set forth above.

1. Financial card sponsor supplies cards to any authorized dealers for issuance to card requesters; and/or the financial card sponsor issues card directly to individual requestors;

2. Cardholder activates card by depositing funds onto card at card activation point (cardholder gives monetary amount to clerk or automated dispenser at participating business who credits card with monetary amount less service charges);

3. Card activation point retains reasonable service charge for performing service of crediting money onto card;

4. Remainder of deposit is forwarded electronically to financial card sponsor who, upon receipt of deposit, takes a service charge and electronically activates balance on cardholder's account;

5. Cardholder submits his/her limit card account number to vendor for purchase of product or service;

6. Vendor accesses account, acknowledges account balance is sufficient to make desired purchase and carries out transaction solely with financial card sponsor;

7. Financial card sponsor transfers funds without any personal information about cardholder to vendor to close transaction; and

8. Product or service is rendered from vendor to cardholder at location provided.

Note that (a) participating card activating sources may receive a service charge deemed reasonable through agreement with financial card sponsor; (b) all commissions or service charges may be received before the card balance is activated; (c) fees and services may be used to enhance profitability, however they are not necessarily required and other means are not precluded from use; and (d) the limit card has no monetary value until the cardholder deposits money onto the card at a card activation point which eliminates risk of card being used fraudulently if lost or stolen before requesting cardholder receives his or her card.

Using the process of the present invention, the cardholder's identity and assets are protected with the only informational transaction taking place between the vendor and the financial institution. No personal information about the cardholder is transferred to the vendor unless the cardholder requests otherwise. There is no need for an account statement being mailed to the account holder unless the cardholder specifically requests one. Thus the paper trail traditionally linking the purchaser's name, address and other personal information with the items purchased is eliminated.

Another embodiment of the present inventive concept encompasses the use of an automated card dispensing and activating device which operates in response to a cash deposit. Activated cards of one or more cash amounts are provided which offer great convenience because of easy accessibility and, in many instances, 24 hour service. Similar computerized transactions take place as occur when clerical personnel are involved with the card activating step triggering an electronic transfer of the card amount to the financial card sponsor and the card sponsor activating the balance on the cardholder's card account. Here too, the transaction is between the card sponsor and the vendor with no information about the cardholder being accessible or reachable unless the cardholder specifically request such.

The techniques involved in forming the novel combination set forth in the present inventive concept and the components associated therewith are unlimited and are deemed readily apparent and obvious to one skilled in the art. All equivalent relationships to those illustrated in the drawings and described in the specification are intended to be encompassed herein. Consequently, the following is considered as illustrative only of the principle of the invention. Since numerous modifications and changes will readily occur to those skilled in the art, it is not desired to limit the invention to the exact construction and operation shown and described. All suitable modifications and equivalents fall within the scope of the appended claims are deemed within the present inventive concept.

What is claimed is:

1. An electronically implemented method for issuing a limit card to a card requestor for a self imposed cash amount to make a product or service purchase with the purchase transaction being conducted solely between the vendor and the financial card sponsor comprising the steps of: receiving a card request by a requestor for a limit card; issuing a non-activated limit card to the requestor; monitoring the deposit by the requestor to the limit card with an initial credit limit; receiving a deposit from a card activating source in the amount of the initial card limit less an appropriate service charge; forwarding the deposit less the service charge to the financial card sponsor; forwarding the received deposit less a service charge to the requestor credit card account to activate the limit card account; monitoring the placement of an order to purchase by the requestor to the vendor of products or services having a cost substantially the same as or less than the deposit to the limit card account; monitoring the shipment or authorization of shipment by the vendor of the product or service to the requestor; and completing the transaction solely with the vendor by transferring the cash value of the product or service from the requestor limit card account to the vendor.

2. An electronically implemented method for issuing a limit card to a card requester for a self imposed cash amount to make a product or service purchase with the purchase transaction being conducted solely between the vendor and financial card sponsor comprising the steps of: receiving a card request from a card requester for a card having a self imposed purchase limit; creating a limit card account with an initial credit limit for the requester in response to the card request; issuing a non-activated card to the requester; monitoring the deposit from the requester in the amount of the initial credit limit to the card; receiving the deposit less an appropriate service charge; electronically forwarding the received deposit less a service charge to the requester card account to activate the card account; monitoring the placement by the requester of an order to the vendor to purchase a product or service having a cost substantially the same as the deposit to the card account; monitoring the transfer by the vendor of the product or service to the requester; and completing the transaction solely with the vendor by transferring the cash value of the product or service from the requestor card account to the vendor.

3. The method as claimed in claim 1 wherein the card is identifiable only by the card sponsoring entity.

4. The method as claimed in claim 1 wherein no account statement is created for the requestor.

5. The method as claimed in claim 1 wherein a self imposed purchase limit is created by the requestor when a purchase is planned.

6. The method as claimed in claim 2 wherein the card is identifiable only by the card sponsoring entity.

7. The method as claimed in claim 2 wherein no account statement is created by the requestor.

8. The method as claimed in claim 2 wherein a self imposed purchase limit is created by the requestor when a purchase is planned.

9. The method as claimed in claim 2 wherein the card is identifiable only by the card sponsoring entity and no account statement is created for the requestor.

10. The method as claimed in claim 2 wherein no account statement is created for the requestor and a self imposed purchase limit is created by the requestor when a purchase is planned.

11. The method as claimed in claim 2 wherein the card is identifiable only by the card sponsoring entity, no account statement is created for the requestor, and a self imposed purchase limit is created by the requestor when a purchase is planned.

12. The method as claimed in claim 1 wherein all personal information concerning the requestor involved in the transaction is known only to the financial card sponsor.

13. The method as claimed in claim 2 wherein all personal information concerning the requestor involved in the transaction is known only to the financial card sponsor and the financial sponsor issues a pin number to the cardholder before or at the time of the activation which must be used each time the account is accessed.

14. The method as claimed in claim 9 wherein all personal information concerning the requestor involved in the transaction is known only to the financial card sponsor.

15. The method as claimed in claim 10 wherein all personal information concerning the requestor involved in the transaction is known only to the financial card sponsor.

16. The method as claimed in claim 11 wherein all personal information concerning the requestor involved in the transaction is known only to the financial card sponsor.

17. An electronically implemented system for issuing a limit card to a card requestor for a self imposed cash amount to make a product or service purchase with the purchase transaction being conducted solely between the vendor and the financial card sponsor comprising: a card requestor seeking to purchase a limit card; a card activating entity for receiving a cash deposit from the card requestor substantially equal to or greater than the purchase limit and posting the deposit onto the card to activate the card; a financial card sponsor for receiving the deposit less an appropriate service charge from the card activating entity and activating the cash limit on the card of the card requestor; and a vendor accepting the card cash amount in return for providing products or services to the requestor, the financial sponsor and the vendor solely completing the transaction by the financial sponsor transferring the card account amount to the vendor.

18. The system as claimed in claim 17 wherein the card is identifiable only by the financial card sponsor.

19. The system as claimed in claim 17 wherein no account statement is created for the requestor.

20. The system as claimed in claim 18 wherein no account statement is created for the requestor.

21. A computer implemented method for issuing a limit card to a card requestor for a self imposed cash amount to make a product or service purchase with the purchase transaction being conducted solely between the vendor and the financial card sponsor comprising the steps of: receiving a card request by a requester at a card providing source for a limit card; issuing a card to the requestor upon the deposit by the requestor of a cash amount equal to or greater than the initial cash limit; forwarding the deposit less the service charge to the financial card sponsor; forwarding the received deposit less a service charge to the requestor card account to activate the card account upon the occurrence of a planned event; monitoring the placement of an order to purchase by the requestor to a vendor of products or services having a cost substantially the same as or less than the deposit to the card account; monitoring the shipment or authorization of shipment by the vendor of the product or service to the requestor; and completing the transaction solely with the vendor by transferring the cash value of the product or service from the requestor card account to the vendor.

22. An electronically implemented system for issuing a limit card to a card requestor for a self imposed cash amount to make a product or service purchase with the purchase transaction being conducted solely between the vendor and the financial card sponsor comprising: a card issuing and activating source for receiving a cash deposit from the requestor substantially equal to or greater than the card limit and posting the deposit onto the card to activate the card at a preselected time; a financial card sponsor for receiving the deposit from the card issuing and activating source and activating the cash limit on the card of the card requestor; and a vendor accepting the card cash amount in return for providing products or services to the requestor, the financial sponsor and the vendor solely completing the transaction by the financial sponsor transferring the card account amount to the vendor.

23. The method as claimed in claim 1 wherein the card requestor is given a receipt at the time of card purchase recording the card purchase transaction.

24. The method as claimed in claim 2 wherein the card requestor is given a receipt at the time of card purchase recording the card purchase transaction.

25. The method as claimed in claim 22 wherein the card requestor is given a receipt at the time of card purchase recording the card purchase transaction.
